(19) United States
(12) Patent Application Publication
(10) Pub. No.: US 2003/0033164 A1
(43) Pub. Date: Feb. 13, 2003

(54) Systems and methods for graphically displaying travel information

(76) Inventors: Boi Faltings, Preverenges (CH); Marc Torrens, Lausanne (CH)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/209,259

(22) Filed: Jul. 30, 2002

Related U.S. Application Data
(60) Provisional application No. 60/308,964, filed on Jul. 30, 2001.

(51) Int. Cl. G06F 17/60

(52) U.S. Cl. 705/1; 705/5

(57) ABSTRACT

A system for identifying, comparing, scheduling and purchasing travel-related services. The system is preferably configured for: (1) receiving one or more travel constraints from a user; (2) identifying a plurality of travel itineraries that satisfy at least one of said travel constraints; (3) simultaneously displaying, on a display screen, a graphical representation of each identified travel itinerary and an alphanumeric description of a currently-selected travel itinerary. The user may quickly view the description of any particular displayed itinerary by selecting the graphical representation of that particular itinerary. Once the new itinerary is selected, the system highlights the graphical representation of the new itinerary and displays an alphanumeric description of the new itinerary. The system applies similar techniques in allowing users to define and view the various travel segments (and related travel constraints) that form the basis of the system's search for suitable travel itineraries.

### CROSS REFERENCE TO RELATED APPLICATION

This application claims the benefit of U.S. Provisional Application Serial No. 60/308,964, which was filed Jul. 30, 2001 and entitled “Systems and Methods for Graphically Displaying Travel Information.”

### FIELD OF THE INVENTION

This invention relates generally to systems for graphically displaying information to a user, and particularly relates to a travel reservation system that allows users to quickly and easily identify, compare, schedule and purchase travel-related services.

### BACKGROUND OF THE INVENTION

Travel agents and other users routinely use computer systems to obtain travel information (such as available flights and airfares), and to reserve and purchase various travel-related services. These computer systems typically first ask the user to input travel constraints (such as desired departure and arrival dates and times). The systems then generate a text listing of available travel options that satisfy the specified travel constraints. The user must then sort through the text listing to identify the best available travel options (e.g., flights, train trips, rental cars) for their particular trip.

While these prior art systems are useful, because they are entirely text-based, they require users to sort through lengthy lists of information to find the best travel options available for a particular trip. This can be difficult and time consuming, especially in situations where the user is attempting to schedule a trip having multiple trip segments. In addition, users must often scroll through a long list of travel options to compare two or more travel options, which can also prove to be difficult and time consuming.

Accordingly, there is a need in the art for a computer-based travel information system that allows users to quickly and easily identify, compare, schedule and purchase travel-related services.

### SUMMARY OF THE INVENTION

The present invention provides a computer-based travel information system that allows users to quickly and easily identify, compare, schedule and purchase travel-related services. More particularly, a system according to one embodiment of the invention is configured for: (1) receiving one or more travel constraints from a user; (2) identifying a first travel itinerary that satisfies (or at least substantially satisfies) at least one of the travel constraints; (3) displaying, on a display screen, a graphical representation of at least a portion of the first travel itinerary; and (4) while displaying the graphical representation of the first travel itinerary on the display screen, displaying, on the display screen, an alphanumeric description of at least a portion of the first travel itinerary. The system may also be configured for: (5) identifying a second travel itinerary that satisfies (or at least substantially satisfies) at least one of the travel constraints; and (6) while displaying the graphical representation of at least a portion of the first travel itinerary on the display screen, displaying a graphical representation of at least a portion of the second travel itinerary on the display screen.

In one embodiment of the invention, the graphical representation of at least a portion of the first itinerary comprises a graphical representation of a first travel path that corresponds to at least a portion of the first travel itinerary. Similarly, the graphical representation of at least a portion of the second itinerary comprises a graphical representation of a second travel path, the second travel path corresponding to at least a portion of the second travel itinerary. In this embodiment of the invention, the graphical representation of at least a portion of the first travel itinerary and the graphical representation of at least a portion of the second travel itinerary are both superimposed on a geographical map. In one particular embodiment of the invention, the graphical representation of at least a portion of the first itinerary comprises a graphical representation of substantially all of the travel segments that comprise the first itinerary, and the graphical representation of at least a portion of the second itinerary comprises a graphical representation of substantially all of the travel segments that comprise the second itinerary.

In a particular embodiment of the invention, the system is further configured for allowing the user to select the second travel itinerary, and, in response to the user selecting the second travel itinerary: (i) removing the alphanumeric description of at least a portion of the first travel itinerary from the display screen; and (ii) while displaying, on the display screen, both the graphical representation of at least a portion of the first travel itinerary and the graphical representation of at least a portion of the second travel itinerary, displaying an alphanumeric description of at least a portion of the second travel itinerary on the display screen. This alphanumeric description preferably comprises arrival times and departure times for a plurality of travel segments within the second travel itinerary.

In one embodiment of the invention, the system is further configured for, in response to the user selecting the second travel itinerary, modifying the graphical representation of at least a portion of the second travel itinerary to further distinguish the graphical representation of at least a portion of the second travel itinerary from the graphical representation of at least a portion of the first travel itinerary.

Another embodiment of the invention comprises a system that is configured for: (1) displaying, on a display screen, a graphical representation of a first travel segment within a travel itinerary; (2) displaying, on the display screen, a graphical representation of a second travel segment within the travel itinerary; (3) allowing a user to select the first travel segment; and (4) in response to the user selecting the first travel segment, modifying the graphical representation of the first travel segment to further distinguish the graphical representation of the first travel segment from the graphical representation of the second travel segment. This system is preferably configured for superimposing both the graphical representation of the first travel segment and a graphical representation of the second travel segment on a geographical map, such as a map of the world.

In one embodiment of the invention, the system is further configured for, in response to the user selecting the first travel segment, displaying, on the display screen, an alphanumeric description of one or more attributes of the first travel segment. Furthermore, the system is preferably configured for allowing the user to select the second travel segment, and, in response to the user selecting the second travel segment, modifying the graphical representation of the second travel segment to further distinguish the graphical representation of the second travel segment from the graphical representation of the first travel segment. In this embodiment of the invention, the system is further configured for, in response to the user selecting the second travel segment, displaying, on the display screen, an alphanumeric representation of one or more attributes of the second travel segment. In one embodiment of the invention, the one or more attributes of the second travel segment comprise an arrival time and departure time that are associated with the travel segment.

A system according to yet another embodiment of the invention is configured to (1) receive one or more travel constraints from a user; (2) identify both a first travel itinerary and a second travel itinerary, the first and second travel itineraries each satisfying (or at least substantially satisfying) at least one of the one or more travel constraints; (3) display, to the user, a graphical depiction of at least a portion of the first travel itinerary, the graphical depiction of at least a portion of the first travel itinerary comprising at least one travel segment; (4) display, to the user, a graphical depiction of at least a portion of the second travel itinerary, the graphical depiction of at least a portion of the second travel itinerary comprising at least one travel segment; (5) allow the user to select the first travel itinerary; and (6) in response to the user selecting the first travel itinerary, modifying the graphical depiction of at least a portion of the first travel itinerary to further distinguish the graphical depiction of at least a portion of the first travel itinerary from the graphical depiction of at least a portion of the second travel itinerary.

In a particular embodiment of the invention, in response to the user selecting the first travel itinerary, the system displays, to the user, a departure time, an arrival time, a carrier, and/or a length of a particular layover associated with the first travel itinerary. In one embodiment of the invention, the system is configured to identify the first and second travel itineraries by retrieving information from a travel information database.

A further embodiment of the invention comprises a system for providing travel-related information that is configured for: (1) receiving a first set of segment definition information from a user, the first set of segment definition information corresponding to a first travel segment; (2) in response to receiving the first set of segment definition information from the user, displaying a graphical representation of the first travel segment on a display screen; (3) receiving a second set of segment definition information from the user, the second set of segment definition information corresponding to a second travel segment; and (4) in response to receiving the second set of segment definition information from the user, displaying a graphical representation of the second segment on a display screen. In one embodiment of the invention, the system is configured for: (5) allowing the user to request that the system search for travel itineraries that at least substantially satisfy the first and second sets of segment definition information; (6) in response to the user's search request, searching for travel itineraries that at least substantially satisfy the first and second sets of segment definition information; and (7) displaying, to the user, a plurality of travel itineraries that at least substantially satisfy the first and second sets of segment definition information.

The invention described above is expressed in terms of systems that are configured for executing, or that include, various steps. However, one skilled in the relevant field will understand that the invention also includes methods that include the steps executed by the above-described systems. Furthermore, one skilled in the relevant field will appreciate that the invention also includes computer-readable media that include computer-executable instructions for executing the steps executed by the above-described systems.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system according to a preferred embodiment of the present invention.

FIG. 2 is a block diagram of a Travel Information Processing Server according to a preferred embodiment of the invention.

FIGS. 3 through 6 are graphical illustrations of various “itinerary definition” windows according to one embodiment of the invention.

FIGS. 7 through 9 are a graphical illustrations of various “itinerary selection” windows according to one embodiment of the invention.

### DETAILED DESCRIPTION OF THE INVENTION

The present invention is described hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and to series of logical “steps” that depict methods, apparatuses (i.e., systems) and computer program products according to an embodiment of the invention. It will be understood that each block of the block diagrams and each logical “step” of the methods described below, (as well as combinations of blocks in the block diagrams and combinations of the “steps” in the methods described below) can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the logical steps described below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the logical steps described below. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified the logical steps described below.

Accordingly, blocks of the block diagrams and the logical steps described below support combinations of means for performing the specified functions, combinations of steps for performing the specified functions and program instruction means for performing the specified functions. It will also be understood that each block of the block diagrams and each logical step described below, and combinations of the blocks in the block diagrams and the steps described below, can be implemented by special purpose hardware-based computer systems that perform the specified functions or steps, or combinations of special purpose hardware and computer instructions.

System Architecture

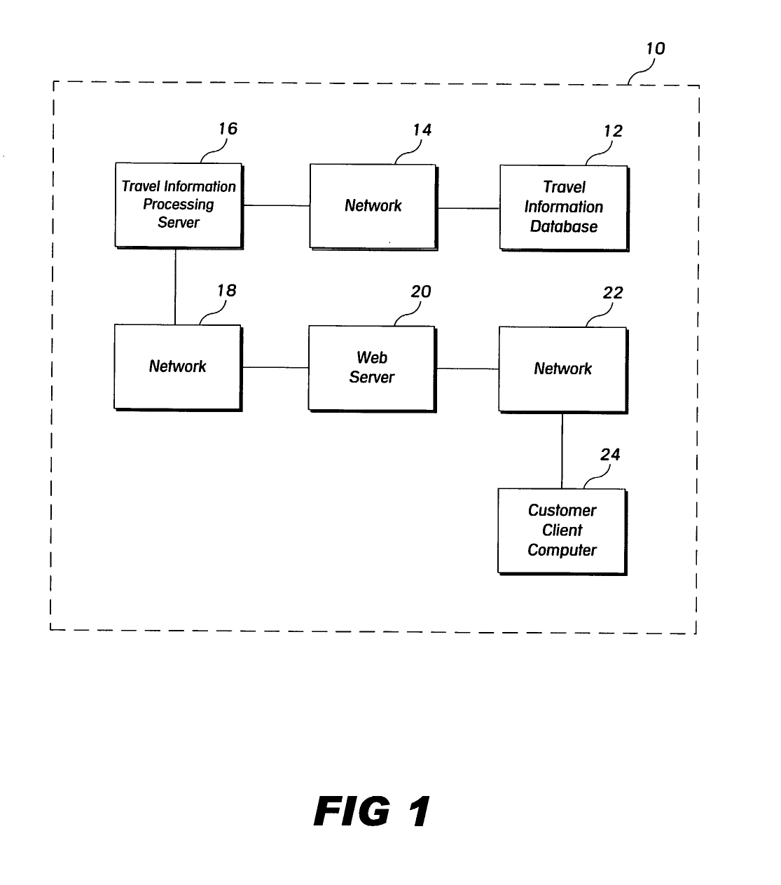

FIG. 1 shows a block diagram of a travel information system 10 in accordance with a preferred embodiment of the present invention. As may be understood from this figure, the travel information system 10 includes a customer client computer 24, one or more computer networks 14, 18, 22, a web server 20, a travel information processing server 16, and a travel information database 12. As can be appreciated by one of ordinary skill in the art, various computer networks 14, 18, 22 facilitate communication between the customer client computer 24 and the web server 20, between the web server 20 and the travel information processing server 16, and between the travel information database 12 and the travel information processing server 16. These computer networks 14, 18, 22 may include any of a variety of types of computer networks such as the Internet, a private intranet, a public switch telephone network (PSTN), or any other type of network known in the art. In a preferred embodiment of the invention, the Internet is used both as the network 14 connecting the travel information database 12 to the travel information processing server 16, and as the network 22 connecting the customer client computer 24 to the web server 20. In this preferred embodiment of the invention, the network connecting the web server 20 to the travel information processing server 16 is a Local Area Network (LAN) 35.

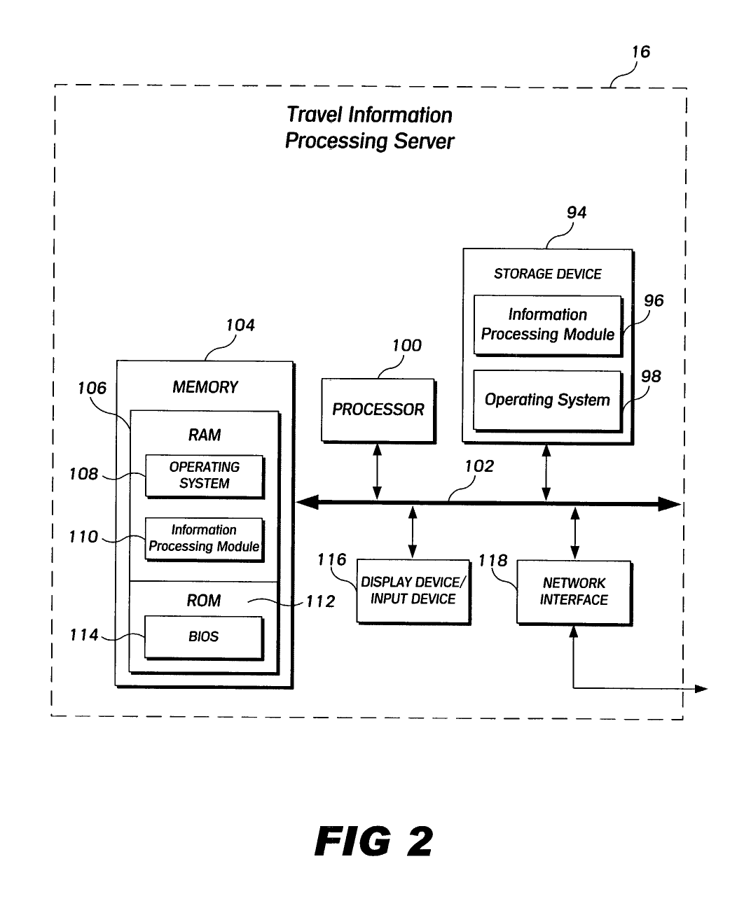

FIG. 2 shows a block diagram of an exemplary embodiment of the travel information processing server 16 of FIG. 1. The travel information processing server 16 includes a processor 100 that communicates with other elements within the travel information processing server 16 via a system interface or bus 102. Also included in the travel information processing server 16 is a display device/input device 116 for receiving and displaying data. This display device/input device 116 may be, for example, a keyboard or pointing device that is used in combination with a monitor. The travel information processing server 16 further includes memory 104, which preferably includes both read only memory (ROM) 112 and random access memory (RAM) 106. The server's ROM 112 is used to store a basic input/output system 114 (BIOS), containing the basic routines that help to transfer information between elements within the travel information processing server 16.

In addition, the travel information processing server 16 includes at least one storage device 94, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 94 is connected to the system bus 102 by an appropriate interface. The storage devices 94 and their associated computer-readable media provide nonvolatile storage for the travel information processing server 16. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 106. Such program modules include an operating system 108, and an information processing module 110. The information processing module 110 controls certain aspects of the operation of the travel information processing server 16, as is described in more detail below, with the assistance of the processor 100 and an operating system 108.

Also located within the travel information processing server 16 is a network interface 118, for interfacing and communicating with other elements of a computer network. It will be appreciated by one of ordinary skill in the art that one or more of the travel information processing server 16 components may be located geographically remotely from other travel information processing server 16 components. Furthermore, one or more of the components may be combined, and additional components performing functions described herein may be included in the travel information processing server 16.

Definitions

As used in this specification, the term “itinerary” refers to one or more individual travel segments (such as flights) that, when combined, would allow a traveler to travel from their ultimate origin point (e.g., origin airport) to their ultimate destination point (e.g., destination airport). For example, an itinerary for a traveler traveling from Atlanta to Frankfurt might include: (1) a July 30 flight from Atlanta to Pittsburgh; (2) a July 30 flight from Pittsburgh to Frankfurt; (3) an August 6 flight from Frankfurt to Charlotte; and (4) an August 6 flight from Charlotte to Atlanta. An alternate itinerary for this traveler might include: (1) a direct July 30 flight from Atlanta to Frankfurt; and (2) a direct August 6 flight from Frankfurt to Atlanta.

Also, as used in this specification, the term “constraint” refers to a requested value for a particular attribute. For example, for a particular travel itinerary, a user might specify a series of constraints on various aspects of the itinerary (e.g., departure date, departure time, arrival date, arrival time, desired number of connections, and preferred airline). As an example, the user might specify that their ultimate departure time from Atlanta should be after 9:00 am on July 30, that their departure time from Frankfurt should be after 5:00 pm on August 6, and that all of their flights should be scheduled on Lufthansa.

For the purposes of this specification an itinerary “substantially satisfies” a particular constraint if the aspect of the itinerary that corresponds to the constraint is slightly outside of the constraint value specified by the user. For example, if the user specifies a constraint of “Depart from Frankfurt before 4:00 pm on Mar. 2, 2002”, a proposed itinerary including a flight that departs from Frankfurt at 4:05 pm on Mar. 2, 2002, would substantially satisfy the “Depart from Frankfurt before 4:00 pm on Mar. 2, 2002 ” constraint.

Overview of the System

In general, a system according to the present invention is operable to generate information relating to various travel products (such as airline flights, bus trips, and train trips) and to display this information in a graphical format that is easy for a user to access, manipulate, and understand. The system is preferably configured to identify the travel products by searching a database for products that satisfy certain constraints specified by a user. In one embodiment of the invention, the system is configured to allow a user to specify these constraints using a unique “itinerary definition” graphical user interface, which is described in greater detail below.

Next, the system searches a database to identify one or more (and typically five, ten or more) travel itineraries that satisfy (or at least substantially satisfy) one or more of the travel constraints specified by the user. The system then displays information relating to the identified travel itineraries using a unique graphical “itinerary selection” graphical user interface, which is also described in greater detail below.

In a preferred embodiment of the invention, the back end of the system is similar to the back end of the systems described in: (1) U.S. patent application Ser. No. 09/571,202, which was filed on May 16, 2000 and entitled “Methods for Providing a Selection Tool”; and (2) U.S. patent application Ser. No. 09/229,701, which was filed on Jan. 12, 1999 and entitled “Methods for Providing Catalogs Through a Network”. Both of these two patent applications are hereby incorporated herein by reference.

In one embodiment of the invention, which is shown generally in FIG. 1, a user logs onto a web site that is being run on a web server 20. The user then uses the web site (and preferably an “itinerary definition” graphical user interface displayed on the web site) to specify an initial set of travel constraints. These specified travel constraints are then transmitted to a Travel Information Processing Server 16, which identifies one or more travel itineraries that satisfy one or more of the specified travel constraints. In a preferred embodiment of the invention, the Travel Information Processing Server 16 identifies the travel itineraries by accessing a Travel Information Database 12, which may be stored on the Travel Information Processing Server 16. Alternatively, the Travel Information Processing Server 16 may access the Flight Information Database 12 over a network 14, as shown in FIG. 1. The resulting travel itineraries are then transferred to the Web Server 20 and displayed to the user (preferably via an “itinerary selection” graphical user interface) on the display screen of Customer Client Computer 24. If desired, the user can then modify their initial travel constraints and search the downloaded travel itineraries based on these modified constraints.

“Itinerary Definition” Graphical User Interface

As noted above, the system preferably includes an “itinerary definition” graphical user interface window 30 that is configured to allow a user to define an itinerary by adding or removing travel segments from the itinerary, and by specifying constraints associated with each travel segment. As each travel segment is added, the itinerary route indicator of the current itinerary is updated to include a portion that extends between the segment's specific origin and destination points (e.g., airports). This portion is referred to as a segment route indicator 50, 52, 54, 56, 58. Thus, for example, if a user were to add a segment that originates in Barcelona and ends in Atlanta, the system would update the itinerary route indicator displayed on the Itinerary Definition window 30 to include a segment route indicator 52 that extends from Barcelona to Atlanta.

In a preferred embodiment of the invention, a user may select one or more of (and preferably any of) the segments within a given itinerary by clicking on the segment route indicator 50, 52, 54, 56, 58 that corresponds to that segment. When the user selects a particular segment route indicator 50, 52, 54, 56, 58, the system visually distinguishes the selected segment route indicator 50, 52, 54, 56, 58 from the other segment route indicators by, for example, displaying the selected segment route indicator 50, 52, 54, 56, 58 in a different color, a different line-style, or a different line-width as the other segment route indicators 50, 52, 54, 56, 58.

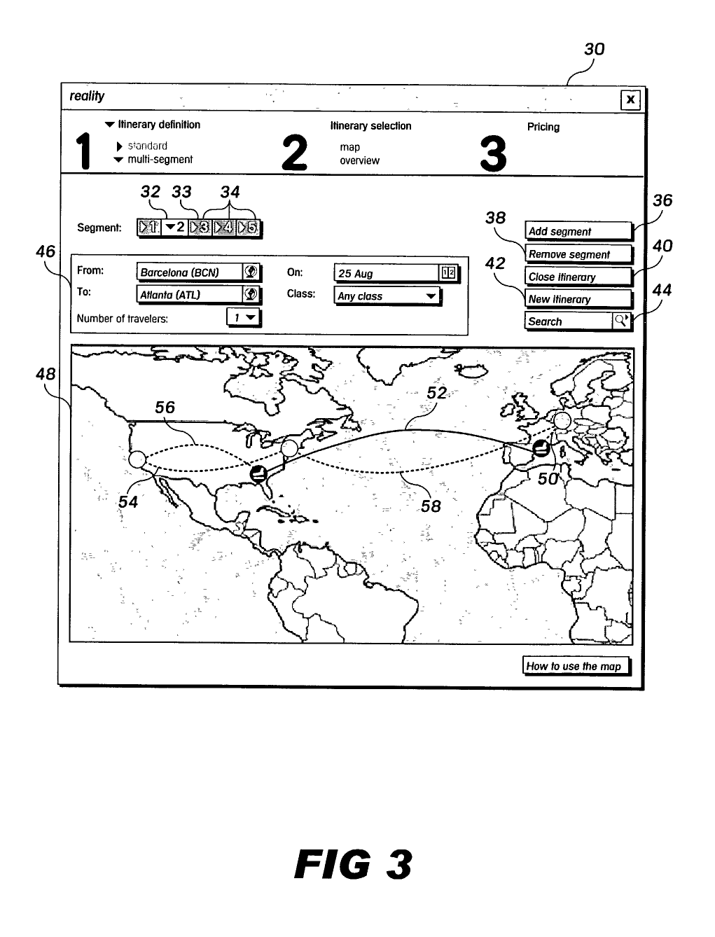

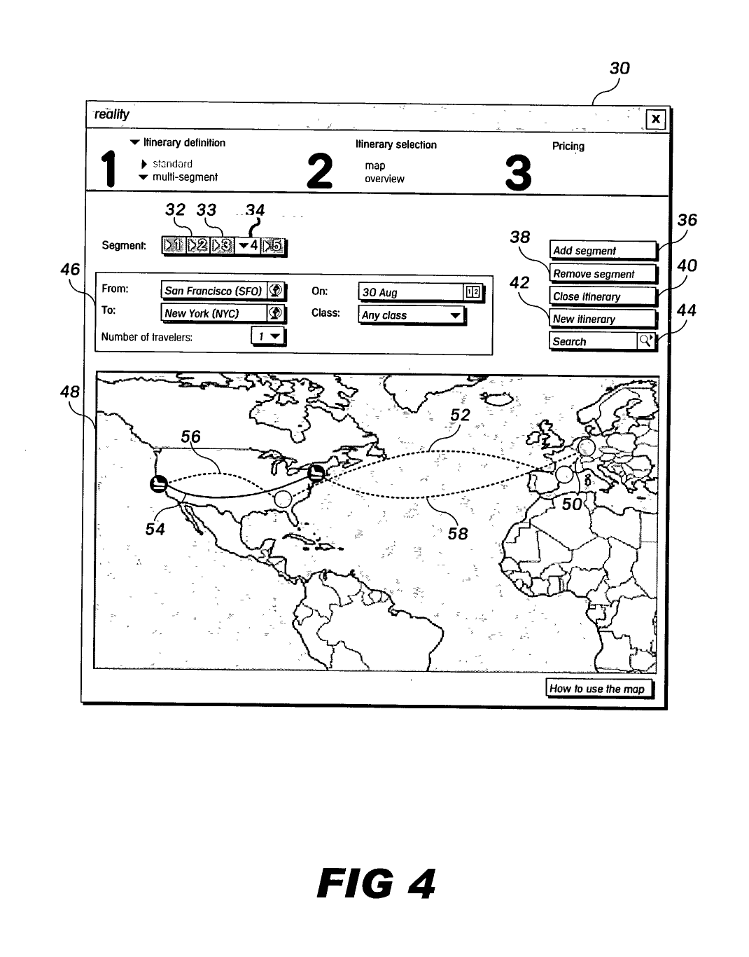

In a preferred embodiment of the invention, one or more particular segments may be selected by selecting a graphical input member (such as a button) that corresponds to the particular segment. For example, as may be understood from FIG. 3, a user may select a second segment (which corresponds to segment route indicator 52) by clicking on a segment button 32 within the Itinerary Definition window 30. Similarly, as may be understood from FIG. 4, a user may select a fourth segment (which corresponds to segment route indicator 54) by clicking on a segment button 34 within the Itinerary Display window 30.

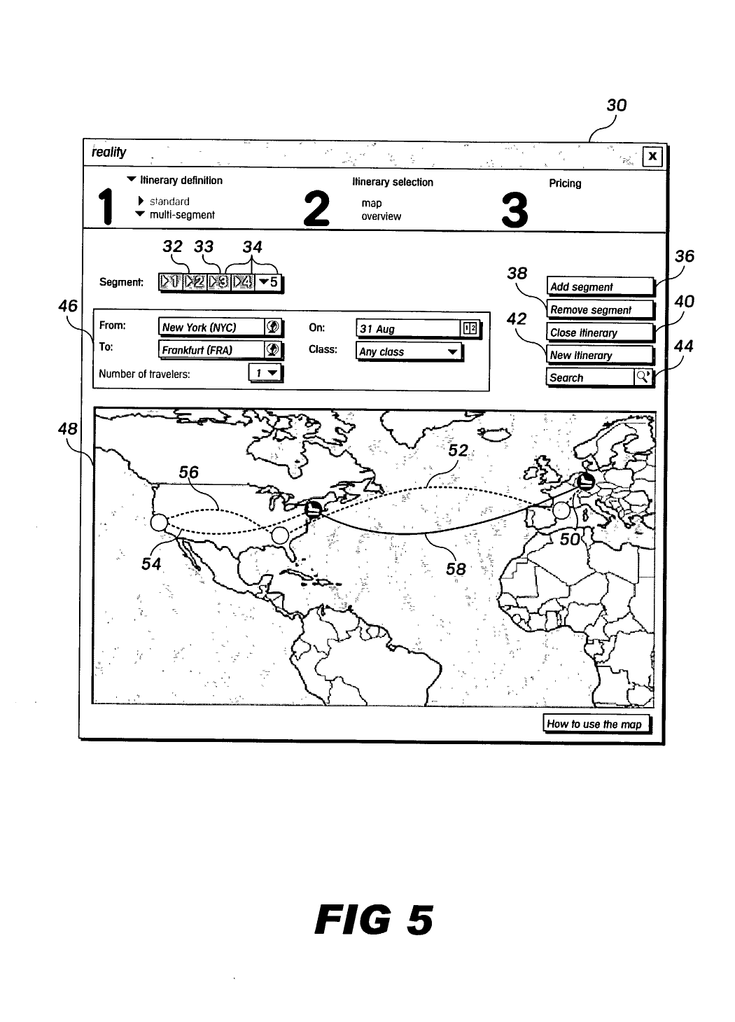

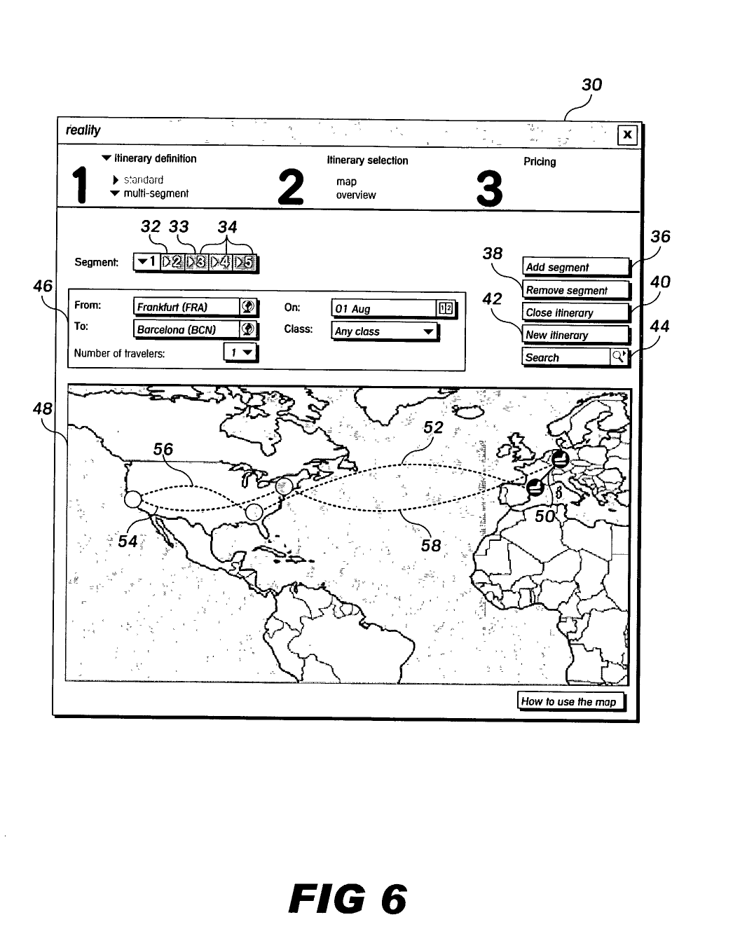

As shown in FIG. 3, when a segment is selected, one or more constraints specified for that segment are displayed within a constraint display/entry portion 46 of the Itinerary Display window 30. The user may preferably change these constraints by, for example, clicking on the constraint and typing in the desired constraint. FIGS. 3 through 6 depict the Itinerary Definition window 30 where the second, fourth, fifth, and first segments of the itinerary, respectively, are selected.

Itinerary Selection Graphical User Interface

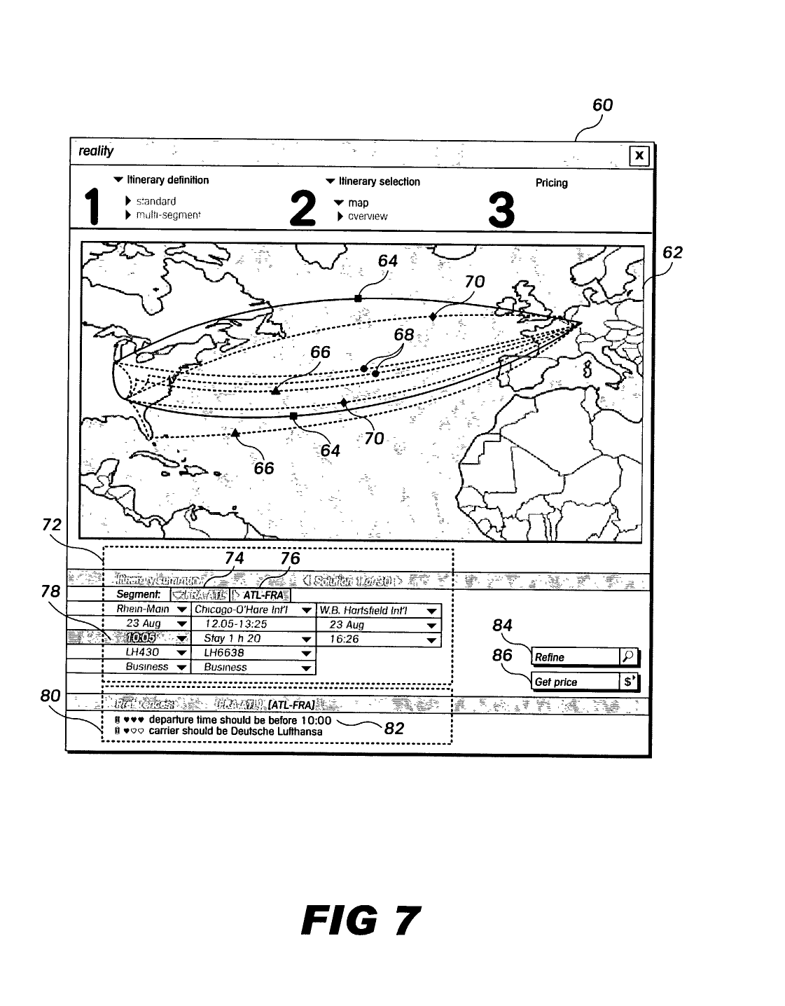

As noted above, after the user defines a desired itinerary (and the various constraints associated with the desired itinerary), the system identifies one or more itineraries that best satisfy the specified travel constraints. Once the system identifies these itineraries, the system uses an “itinerary selection” user interface (such as an Itinerary Selection graphical user interface window 60) to graphically display information related to these itineraries to the user. An Itinerary Selection window 60 according to one embodiment of the invention is shown in FIGS. 7 through 9.

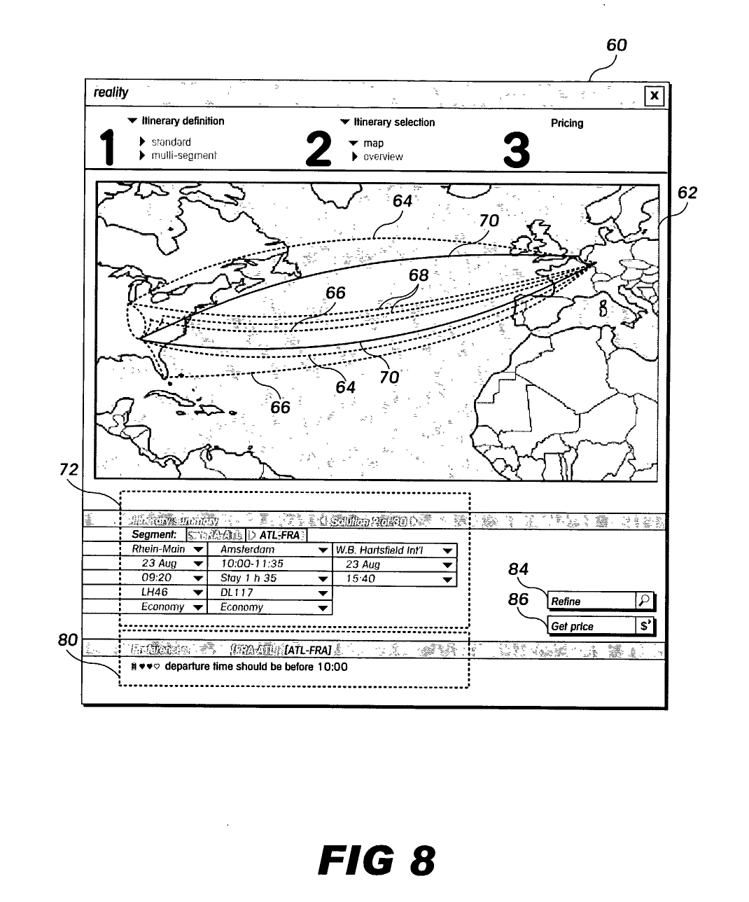

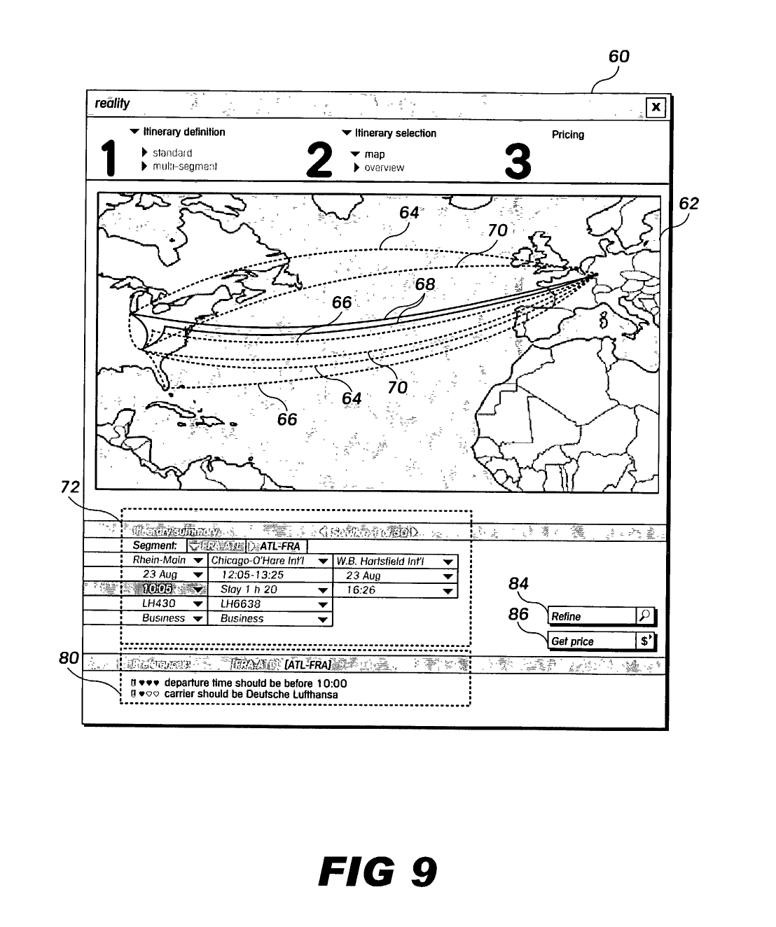

As may be understood from FIG. 7 (which, as is discussed in greater detail below, is a visually-enhanced version of the Itinerary Selection window 60 shown in FIGS. 8 and 9), the system graphically displays this information by superimposing one or more route indicators 64, 66, 68, 70 on a geographical map (such as a full or partial map of the world). Each of these route indicators 64, 66, 68, 70 graphically depicts each of the individual travels (e.g., flights) within a particular travel itinerary by providing a line or other indicator that extends between each the point of origin (e.g., origin airport) and the destination (e.g., destination airport) for each travel. In a preferred embodiment of the invention, the system displays route indicators 64, 66, 68, 70 for a plurality of travel itineraries that at least substantially satisfy the travel constraints specified by the user.

In a preferred embodiment of the invention, one or more of the route indicators 64, 66, 68, 70 is user-selectable. Preferably, a user may select a particular itinerary by clicking on the route indicator 64, 66, 68, 70 that corresponds to that itinerary. In response to the user clicking on a particular route indicator 64, 66, 68, 70, the selected route indictor 64, 66, 68, 70 is displayed so that the selected route indicator 64, 66, 68, 70 is visually distinguished from the other route indicators 64, 66, 68, 70. For example, the selected route indicator 64, 66, 68, 70 may be displayed in a different color, line-style, or line width than the other route indicators 64, 66, 68, 70 to visually distinguish the selected route indicator 64, 66, 68, 70 from the other route indicators 64, 66, 68, 70.

As may be understood from FIGS. 7 through 9, in one embodiment of the invention, the route indicators 64, 66, 68, 70 corresponding to all of the itineraries other than a currently selected itinerary are preferably displayed in the same color, line style, and/or line width. The route indicator that corresponds to the selected itinerary is preferably displayed in a different manner (e.g., in a different color, line-style, or line width) to visually distinguish the selected route indicator from the other route indicators. For example, in FIG. 8, the selected route indicator 70 is displayed as a dark solid line and all of the other (non-selected) route indicators 64, 66, 68 are displayed as dashed lines.

FIG. 7 has been visually enhanced for illustration purposes. For example, two squares have been added to the route indicator 64 that corresponds to the first itinerary to distinguish this route indicator 64 from the other route indicators 66, 68, 70. Similarly, the route indicator 68 that corresponds to a second itinerary includes two circles to distinguish this route indicator 68 from the other route indicators 64, 66, 70. Furthermore, the route indicator 66 that corresponds to a third itinerary includes two triangles to distinguish this route indicator 66 from the other route indicators 64, 68, 70. In addition, the route indicator 70 that corresponds to a fourth itinerary is includes two diamonds to distinguish this route indicator 70 from the other route indicators 64, 66, 68.

In a preferred embodiment of the invention, when a particular itinerary is selected, information relating to the selected itinerary is displayed in an itinerary summary area 72 within the Itinerary Selection window 60. This information may include, for example, the arrival and departure times of the travels that comprise a segment of the selected itinerary.

In a preferred embodiment of the invention, segment selection buttons 74, 76 are included within the Itinerary Selection window 60 for allowing a user to select a particular segment of the selected itinerary. When this segment is selected, information relating to this particular segment (for example, a segment from Frankfurt to Atlanta) will preferably be displayed in the itinerary summary area 72 of the Itinerary Selection window 60. In a preferred embodiment of the invention, only information corresponding to the selected segment is displayed in the itinerary summary area 72 of the itinerary selection window 60. In a further preferred embodiment of the invention, the window includes a preferences area 80 for displaying travel constraints associated with the currently selected segment.

It should be understood that a user may preferably select freely between the various itineraries displayed within the Itinerary Selection window 60. For example, as shown in FIG. 8, if a user selects the fourth itinerary 70, the route indicator corresponding to the fourth itinerary 70 is displayed in a unique line type and information pertaining to this itinerary 70 is displayed in the itinerary summary area 72 of the Itinerary Selection window 60.

In a preferred embodiment of the invention, the Itinerary Selection window 60 includes a “get price” button 86 for allowing a user to display a price associated with the currently selected itinerary. In a further embodiment of the invention, the Itinerary Selection window 60 includes a refine button 84 for allowing user to specify new constraints and then refine the display to show itineraries that satisfy the new constraints. In a further preferred embodiment of the invention, the system is configured to allow the user to zoom in on certain areas of the map, and to zoom out to provide a less focused view of the map.

Use and Operation of a Preferred Embodiment of the Invention

To use a preferred embodiment of the invention, the user first uses a Customer Client Computer 24 to log on to a travel scheduling website. The user then specifies, in any manner known in the art, that the user wishes to develop a travel itinerary for a particular trip. The user is then presented with an Itinerary Definition window 30, which is similar to the Itinerary Definition window 30 shown in FIGS. 3 through 6 except that the graphic display portion 62 of the Itinerary Definition window 30 includes only a map, and does not yet include any segment route indicators 50, 52, 54, 56, 58. The user then enters constraints applicable to the new segment in a constraint display/entry portion 46 of the Itinerary Definition window 30. As may be understood from FIGS. 3 through 6, this information may include the origin and destination airports for the segment, the desired date of the segment, a class of service for the segment (e.g., first class or economy class), and the desired number of travelers.

After the user has finished adding information for a particular segment, the user selects an Add Segment button 36. In response to the user selecting this button, the system displays a segment route indictor 50, 52, 54, 56, 58 that corresponds to the new segment. The user may then enter additional segments in this same manner until all of the desired segments have been defined. The user may remove segments as desired by selecting the segment in the manner set forth above and then selecting a Remove Segment button 38.

In the course of defining the various segments that make up a travel itinerary, the user may select the various segments as described above. In response to any particular segment being selected, the system displays the current attributes of the selected segment in the constraint display/entry portion 46 of the Itinerary Definition window 30. In a preferred embodiment of the invention, in response to a new segment being selected, the system removes from display the attributes of all other (non-selected) segments. The user may edit the segment attributes by modifying the information displayed within the constraint display/entry portion 46 of this window 30.

Once the user has defined all of the segments within their proposed travel itinerary, the user selects a search button 44 to begin searching for actual travel itineraries that at least substantially satisfy the constraints of the user's proposed travel itinerary. Thus, in response to the user selecting the search button 44, the system searches a travel information database to identify various alternative travel options that satisfy the segment constraints defined by the user within the Itinerary Definition window 30.

For example, if the user uses the Itinerary Definition window 30 to define an itinerary for a round trip flight from Frankfurt to Atlanta, the system would display various alternative travel itineraries for the trip from Frankfurt to Atlanta. In a preferred embodiment of the invention, the system displays the alternative travel itineraries within an Itinerary Selection window 60, such as the Itinerary Selection window 60 depicted in FIGS. 7 through 9. These figures display an exemplary Itinerary Selection window 60 that is displaying a set of suggested travel itineraries for a Frankfurt to Atlanta round trip flight.

As may be understood from these figures, the Itinerary Selection window 60 preferably displays visual representations of a plurality of different travel itineraries that satisfy (or at least substantially satisfy) at least one of the travel constraints set forth within the Itinerary Definition window 30. The various travel itineraries may differ, for example, in: (1) number of connections; (2) layover cities; (3) layover time; (4) carrier; (5) class of service; (6) type of craft (type of aircraft, ship, or train), and (6) cost.

After the system displays the available itineraries in the Itinerary Selection window 60, the user may view a summary of a particular itinerary by selecting the route indicator 64, 66, 68, 70 that corresponds to that particular itinerary. As noted above, in a preferred embodiment of the invention, the user may select a particular itinerary by using a mouse to click on a graphical depiction of the particular itinerary (e.g., a route indictor 64, 66, 68, 70).

As shown in FIGS. 7 through 9, in response to the user selecting a particular itinerary, the system displays information related to the selected itinerary. In a preferred embodiment of the invention, in response to the user selecting a particular itinerary, the system displays an alphanumeric description of at least a portion of the selected itinerary. Also, in response to the user selecting a particular itinerary, the system preferably removes from display the alphanumeric description of the previously-selected itinerary.

In one embodiment of the invention, in response to the user selecting a particular itinerary, the system displays a summary of the selected itinerary in an itinerary summary area 72 within the Itinerary Selection display window 60. This summary preferably includes at least the departure and arrival places and times for each travel segment within at least a portion of the selected travel itinerary.

In one embodiment of the invention, the system is configured to display a summary of each segment of the selected itinerary separately, and the user may use two or more segment selection buttons 74, 76 to indicate the segment currently selected itinerary for which a summary should be displayed. For example, in the example shown in FIG. 7, the user may display a summary of the Frankfurt-Atlanta segment of the currently-selected itinerary 64 by selecting a first segment selection button 74. Similarly, the user may display a summary of the Atlanta-Frankfurt segment of the currently-selected itinerary 64 by selecting a second segment selection button 76. Displaying summaries of the various segments within the selected travel itinerary separately provides for a clear and uncluttered display of segment information.

As noted above, the system is preferably configured to allow users to freely and quickly select any of the displayed travel itineraries. This is demonstrated by FIGS. 7 through 9. FIG. 8 depicts the same Itinerary Selection window 60 as FIG. 7 except that itinerary 70 is selected rather than itinerary 64. Similarly, FIG. 9 depicts the same Itinerary Selection window 60 as FIG. 7 except that itinerary 68 is selected rather than itinerary 64. By allowing users to select the various travel itineraries quickly and freely, the system enables users to view information regarding their travel alternatives in a clear and easy-to-understand manner.

After viewing information related to various different itineraries, the user may wish to refine their search by specifying additional or different travel constraints. The user may initiate this refining process by selecting a Refine button 84 within the Itinerary Selection window 60.

Once the user is satisfied with a particular travel itinerary, the user may wish to obtain a price for the itinerary. To do this, the user selects a Get Price button 86 within the Itinerary Selection window 60. In response to the user selecting the Get Price button 86, the system displays a pricing window (not shown) which preferably displays a price associated with the currently-selected itinerary, and that allows the user to purchase the itinerary using, for example, known internet-based, telephone-based, or mail-based purchase techniques.

One aspect of the system is that it may display itineraries within the Itinerary Selection window 60 that satisfy (or at least partially satisfy) some, but not all, of the constraints specified within the Itinerary Definition window 30. This allows users to view travel options that do not satisfy all of the user's specified constraints, but that may nonetheless be the most desirable for the user. In one embodiment of the invention, the system includes a “user options” window that allows a user to specify whether to only display itineraries that satisfy all of the specified constraints, or also to display itineraries that satisfy some, but not all, of the specified constraints.

In one embodiment of the invention, the user options window allows users to indicate which constraints must be satisfied by a particular itinerary in order for the itinerary to be displayed within the Itinerary Selection window 60. This user options window also preferably allows users to specify which constraints need not be satisfied, and which constraints need only be substantially satisfied, in order for a particular itinerary to be displayed within the Itinerary Selection window 60. For example, the user may specify that all displayed itineraries must satisfy the specified arrival and departure time and date constraints, but need not satisfy a “preferred carrier” constraint.

Another aspect of the invention is that it may be used to display information related to a wide variety of types of travel. For example, while the invention above is described in relation to an airline reservation system, the system may be used to display information related to travel by plane, bus, train, ship, train, rental car, or any other travel medium. In one embodiment of the invention, the system is configured to allow users to access information related to any of the travel media referenced above, and to display information regarding different travel media within a single display screen. For example, the system may display a single travel itinerary that includes segments that are to be traveled by aircraft, car, and ship, respectively.

Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. For example, one of ordinary skill in the art will understand that, while the above system and methods were described as embodied in a travel reservation system, it should be understood that the inventive system could be used in any system for graphically displaying information. Such systems may, for example, include systems for displaying information related to delivery routes or driving directions. Although specific terms are employed herein, they are used in a generic and descriptive sense only and not for purposes of limitation.

1. A system for providing travel-related information, said system comprising:
a central processing unit; and
a memory coupled to said central processing unit, said central processing unit being configured for:
(A) receiving one or more travel constraints from a user;
(B) identifying a first travel itinerary that at least substantially satisfies at least one of said travel constraints;
(C) displaying, on a display screen, a graphical representation of at least a portion of said first travel itinerary; and
(D) while displaying said graphical representation of said first travel itinerary on said display screen, displaying, on said display screen, an alphanumeric description of at least a portion of said first travel itinerary.

2. The system of claim 1, wherein said graphical representation of said first itinerary comprises a geographical map and a graphical representation of a first travel path, said first travel path corresponding to at least a portion of said first travel itinerary.

3. The system of claim 2, wherein said graphical representation of said first travel path is superimposed on said geographical map.

4. The system of claim 1, wherein said central processing unit is further configured for:
(E) identifying a second travel itinerary that at least substantially satisfies at least one of said travel constraints; and
(F) while displaying said graphical representation of at least a portion of said first travel itinerary on said display screen, displaying a graphical representation of at least a portion of said second travel itinerary on said display screen.

5. The system of claim 4, wherein said central processing unit is further configured for:
(G) identifying a third travel itinerary that at least substantially satisfies at least one of said travel constraints; and
(H) while displaying, on said display screen, both said graphical representation of at least a portion of said first travel itinerary and said graphical representation of at least a portion of said second travel itinerary, displaying, on said display screen, a graphical representation of at least a portion of said third travel itinerary.

6. The system of claim 4, wherein:
said graphical representation of at least a portion of said first itinerary comprises a graphical representation of a first travel path, said first travel path corresponding to at least a portion of said first travel itinerary;
said graphical representation of at least a portion of said second itinerary comprises a graphical representation of a second travel path, said second travel path corresponding to at least a portion of said second travel itinerary; and
wherein both said graphical representation of at least a portion of said first travel itinerary and said graphical representation of at least a portion of said second travel itinerary are superimposed on a geographical map.

7. The system of claim 6, wherein:
said graphical representation of at least a portion of said first itinerary comprises a graphical representation of substantially all of the travel segments that comprise said first itinerary; and
said graphical representation of at least a portion of said second itinerary comprises a graphical representation of substantially all of the travel segments that comprise said second itinerary.

8. The system of claim 4, wherein said central processing unit is further configured for:
(G) allowing said user to select said second travel itinerary; and
(H) in response to said user selecting said second travel itinerary:
(i) removing said alphanumeric description of at least a portion of said first travel itinerary from said display screen; and
(ii) while displaying, on said display screen, both said graphical representation of at least a portion of said first travel itinerary and said graphical representation of at least a portion of said second travel itinerary, displaying an alphanumeric description of at least a portion of said second travel itinerary on said display screen.

9. The system of claim 8, wherein said central processing unit is further configured for, in response to said user selecting said second travel itinerary, modifying said graphical representation of at least a portion of said second travel itinerary to further distinguish said graphical representation of at least a portion of said second travel itinerary from said graphical representation of at least a portion of said first travel itinerary.

10. The system of claim 4, wherein said central processing unit is further configured to allow said user to select said second travel itinerary by selecting said graphical representation of at least a portion of said second travel itinerary with a mouse.

11. The system of claim 4, wherein said alphanumeric description of at least a portion of said first travel itinerary comprises arrival times and departure times for a plurality of travel segments within said first travel itinerary.

12. The system of claim 4, wherein said travel itinerary comprises at least one airline flight.

13. The system of claim 4, wherein said first travel itinerary and said second itinerary represent alternative itineraries for travel between an origin city and a destination city.

14. A system for providing travel-related information, said system comprising:
a central processing unit; and
a memory coupled to said central processing unit, said central processing unit being configured for:
(A) displaying, on a display screen, a graphical representation of a first travel segment within a travel itinerary;
(B) displaying, on said display screen, a graphical representation of a second travel segment within said travel itinerary;
(C) allowing a user to select said first travel segment; and
(D) in response to said user selecting said first travel segment, modifying said graphical representation of said first travel segment to further distinguish said graphical representation of said first travel segment from said graphical representation of said second travel segment.

15. The system of claim 14, wherein said central processing unit is further configured for superimposing both said graphical representation of said first travel segment and said second travel segment on a geographical map.

16. The system of claim 14, wherein said central processing unit is further configured for, in response to said user selecting said first travel segment, displaying, on said display screen, an alphanumeric description of one or more attributes of said first travel segment.

17. The system of claim 14, wherein said central processing unit is configured for:
(E) allowing said user to select said second travel segment; and
(F) in response to said user selecting said second travel segment, modifying said graphical representation of said second travel segment to further distinguish said graphical representation of said second travel segment from said graphical representation of said first travel segment.

18. The system of claim 17, wherein said central processing unit is further configured for, in response to said user selecting said second travel segment, displaying, on said display screen, an alphanumeric representation of one or more attributes of said second travel segment.

19. The system of claim 18, wherein said one or more attributes of said second travel segment comprise an arrival time and departure time, both said arrival time and said departure time being associated with said second travel segment.

20. A method of presenting travel information to a user, said method comprising the steps of:
(A) receiving one or more travel constraints from a user;
(B) identifying both a first travel itinerary and a second travel itinerary, said first and second travel itineraries each satisfying at least one of said one or more travel constraints;
(C) displaying, to said user, a graphical depiction of at least a portion of said first travel itinerary, said graphical depiction of at least a portion of said first travel itinerary comprising at least one travel segment;
(D) displaying, to said user, a graphical depiction of at least a portion of said second travel itinerary, said graphical depiction of at least a portion of said second travel itinerary comprising at least one travel segment;
(D) allowing said user to select said first travel itinerary; and
(E) in response to said user selecting said first travel itinerary, modifying said graphical depiction of at least a portion of said first travel itinerary to further distinguish said graphical depiction of at least a portion of said first travel itinerary from said graphical depiction of at least a portion of said second travel itinerary.

21. The method,of claim 20, wherein said step of identifying both a first travel itinerary and a second travel itinerary comprises retrieving information from a database.

22. The method of claim 20 further comprising the step of, in response to said user selecting said first travel itinerary, displaying, to said user, at least one departure time associated with said first travel itinerary.

23. The method of claim 20 further comprising the step of, in response to said user selecting said first travel itinerary, displaying, to said user, at least one arrival time associated with said first travel itinerary.

24. The method of claim 20 further comprising the step of, in response to said user selecting said first travel itinerary, displaying, to said user, a name of at least one carrier associated with said first travel itinerary.

25. The method of claim 20 further comprising the step of, in response to said user selecting said first travel itinerary, displaying, to said user, a length of a layover associated with said first travel itinerary.

26. The method of claim 20, further comprising the steps of:
(F) in response to said user selecting said first travel itinerary, displaying, to said user, an alphanumeric representation of one or more details associated with said first travel itinerary;
(G) allowing said user to select a second travel itinerary; and
(H) in response to said user selecting said second itinerary:
(i) modifying a graphical depiction of at least a portion of said second travel itinerary;
(ii) removing, from display to said user, said alphanumeric representation of one-or more details associated with said first travel itinerary; and
(iii) displaying, to said user, an alphanumeric representation of attributes of one or more details associated with said second travel itinerary.

27. The method of claim 26, wherein at least one of said one or more details associated with said second travel itinerary is a departure time.

28. A computer-readable medium comprising computer-executable instructions for performing the steps of:
(A) receiving one or more travel constraints from a user;
(B) identifying both a first travel itinerary and a second travel itinerary, said first and second travel itineraries each at least substantially satisfying at least one of said one or more travel constraints;
(C) displaying, to said user, a graphical depiction of at least a portion of said first travel itinerary, said graphical depiction of at least a portion of said first travel itinerary comprising at least one travel segment;
(D) displaying, to said user, a graphical depiction of at least a portion of said second travel itinerary, said graphical depiction of at least a portion of said second travel itinerary comprising at least one travel segment;
(D) allowing said user to select said first travel itinerary; and
(E) in response to said user selecting said first travel itinerary, modifying said graphical depiction of at least a portion of said first travel itinerary to further distinguish said graphical depiction of at least a portion of said first travel itinerary from said graphical depiction of at least a portion of said second travel itinerary.

29. The computer-readable medium of claim 28, further comprising computer-executable instructions for performing the steps of:
(F) in response to said user selecting said first travel itinerary, displaying, to said user, an alphanumeric representation of one or more details associated with said first travel itinerary;
(G) allowing said user to select said second travel itinerary; and
(H) in response to said user selecting said second travel itinerary:
(i) modifying a graphical depiction of at least a portion of said second travel itinerary;
(ii) removing from display to said user said alphanumeric representation of one or more details associated with said first travel itinerary; and
(iii) displaying, to said user, an alphanumeric representation of one or more details associated with said second travel itinerary.

30. A system for providing travel-related information, said system comprising:
a central processing unit; and
a memory coupled to said central processing unit,
said central processing unit being configured for:
(A) receiving a first set of segment definition information from a user, said first set of segment definition information corresponding to a first travel segment;
(B) in response to receiving said first set of segment definition information from a user, displaying a graphical representation of said first travel segment on a display screen;
(C) receiving a second set of segment definition information from a user, said second set of segment definition information corresponding to a second travel segment; and
(D) in response to receiving said second set of segment definition information from said user, displaying a graphical representation of said second segment on a display screen.

31. The system of claim 30, wherein said central processing unit is further configured for:
(A) allowing said user to select said second segment; and
(B) in response to said user selecting said second segment, displaying alphanumeric information corresponding to said second segment.

32. The system of claim 30, wherein said central processing unit is further configured for:
(E) allowing said user to request that said system search for travel itineraries that at least substantially satisfy said first and second sets of segment definition information;
(F) in response to said request, searching for travel itineraries that at least substantially satisfy said first and second sets of segment definition information; and
(G) displaying, to said user, a plurality of travel itineraries that at least substantially satisfy said first and second sets of segment definition information.
